(19) United States
(12) Patent Application Publication
(10) Pub. No.: US 2003/0067659 A1
(43) Pub. Date: Apr. 10, 2003

(54) System for upstream broadband transmission

(76) Inventor: Richard T. Kusiolek, Mtn. View, CA (US)

Correspondence Address: Daniel D. Tagliaferri, Coudert Brothers LLP, Third Floor, 600 Beach Street, San Francisco, CA, 94501, US

(21) Appl. No.: 10/241,379

(22) Filed: Sep. 10, 2002

Related U.S. Application Data
(60) Provisional application No. 60/318,540, filed on Sep. 10, 2001.

(51) Int. Cl. H04B 10/00

(52) U.S. Cl. 359/167; 359/152

(57) ABSTRACT

System for upstream broadband transmission in a communication system. The system includes an optical transceiver for providing upstream broadband transmissions between a plurality of end users and a head-end in a cable communication system. The optical transceiver is located in close proximity to the end users. The optical transceiver comprises a plurality of interface ports, one port for each of the end users, to receive electrical broadband upstream transmissions from each of the end users. The optical transceiver also comprises an optical output port for transmitting optical signals with the head-end, and logic to receive the electrical broadband upstream transmissions and combine them into an upstream optical signal that is transmitted from the optical output port to the head-end.

### CROSS REFERENCE TO RELATED APPLICATIONS

The present invention claims the benefit of priority to a co-pending U.S. Provisional Patent Application entitled “4^{TH} GENERATION BROADBAND FIBER ACCESS DEVICE OPTIMIZED FOR HIGH SPEED IP TRANSMISSION FROM REMOTE TO HEAD-END” filed on Sep. 10, 2001 and having Application No. 60/318,540, the disclosure of which is incorporated herein by reference in its entirety for all purposes.

### FIELD OF THE INVENTION

The present invention relates generally to transmission systems, and more particularly, to a system for providing upstream broadband transmissions in a cable communication system.

### BACKGROUND OF THE INVENTION

Cable systems are generally utilized as one-way systems in which cable signals (mostly television signals) are transmitted from a head-end transmitter via a transmission cable to receiving equipment at an end user's location, such as the user's home. For example, such systems are used to transmit cable television (CTV) signals that occupy a frequency range of 50-550 megahertz (MHz).

Cable modems (CM) are used as receiving equipment at the user's location to provide bi-directional communication between the user's location and the head-end transmitter. The CM transmits data in a frequency rage of about 5-42 MHz (upstream), and receives data form the head-end transmitter in a frequency range of about 550-750 MHz (downstream). The downstream high-speed channel is utilized to provide digitized services to end-users.

In conventional systems, the upstream channel is utilized to transmit small amounts of data to a head-end receiver. Thus, the upstream bandwidth required for each CM is small. However, for some applications, this upstream bandwidth is not adequate. This is especially true in applications where broadband information must be transmitted from the CM to the head-end receiver. Since the frequency range between 50-550 MHz is utilized by all television receivers coupled to the cable network, that frequency range cannot be used for upstream channel applications without adverse affect. Thus, in conventional systems, broadband upstream transmissions are not possible, and so applications requiring such transmission are also not possible.

Therefore, it would be desirable to have a system that allows end users to transmit upstream broadband signals between the CM and the head-end receiver to accommodate applications that require a large upstream frequency band.

### SUMMARY OF THE INVENTION

The present invention includes an optical transceiver for use in a communication system to allow end users to transmit upstream broadband signals to a head-end. In an optical transmission, the optical upstream and downstream signals do not interfere with each other, so that a large optical bandwidth is available for both the upstream and downstream transmissions. The large upstream optical bandwidth is divided among a plurality of end users so that each end user has enough bandwidth to transmit broadband upstream signals. Thus, a communication system constructed in accordance with the present invention can run applications that require large upstream bandwidth. Such applications would not be possible in conventional communication systems, where the upstream bandwidth is limited.

One embodiment included in the present invention provides a system for providing upstream broadband transmissions between a plurality of end users and a headend in a cable communication system. The system comprises a first optical transceiver located at the head-end and coupled to a first end of an optical transmission cable. The system also comprises a second optical transceiver located in close proximity to the end users, wherein the second optical transceiver is coupled to a second end of the optical transmission cable, and wherein the second optical transceiver comprises a plurality of interface ports, one port for each of the end users, to receive broadband upstream transmissions from each of the end users. The second optical transceiver also comprises logic to receive the broadband upstream transmissions and combine them into an optical signal that is transmitted on the optical transmission cable to the first optical transceiver.

Another embodiment included in the present invention provides an optical transceiver for providing upstream broadband transmissions between a plurality of end users and a head-end in a cable communication system. The optical transceiver is located in close proximity to the end users. The optical transceiver comprises a plurality of interface ports, one port for each of the end users, to receive electrical broadband upstream transmissions from each of the end users. The optical transceiver also comprises an optical output port for transmitting optical signals with the head-end, and logic to receive the electrical broadband upstream transmissions and combine them into an upstream optical signal that is transmitted from the optical output port to the head-end.

### BRIEF DESCRIPTION OF THE DRAWINGS

The foregoing aspects and the attendant advantages of this invention will become more readily apparent by reference to the following detailed description when taken in conjunction with the accompanying drawings wherein:

FIG. 1 shows a diagram of one embodiment of a communication system constructed in accordance with the present invention that allows end users to transmit upstream broadband signals; and

FIG. 2 is a block diagram of one embodiment of an optical transceiver constructed in accordance with the present invention.

### DETAILED DESCRIPTION

The present invention includes a communication system that allows end users to transmit upstream broadband signals to a head-end. Embodiments of the invention are suitable for use in any communication system, and in particular, very well suited for use with interactive cable television systems.

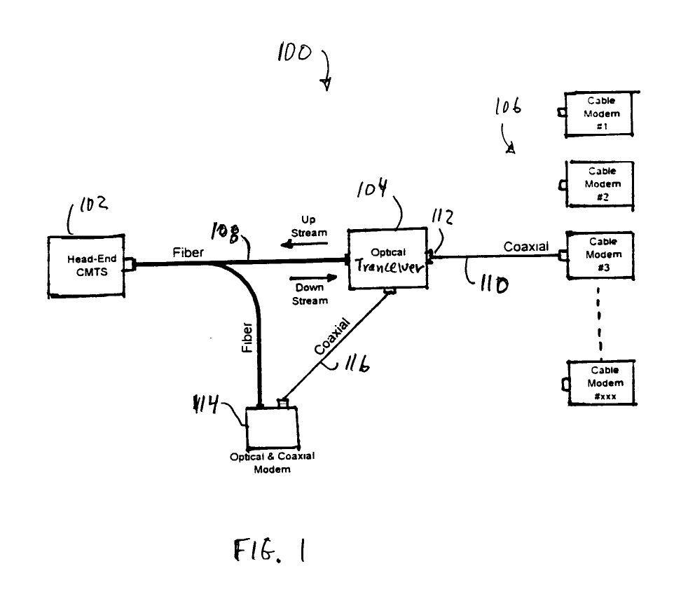

FIG. 1 shows a diagram of one embodiment of a communication system 100 constructed in accordance with the present invention that allows end users to transmit upstream broadband signals. The communication system 100 includes a head-end 102, an optical transceiver 104 and a plurality of cable modems, shown generally at 106, that are used for each end-user. An optical fiber cable 108 is connected between the head-end 102 and the optical transceiver 104. The optical fiber provides a large bandwidth for both upstream and downstream transmissions.

The optical transceiver 104 is coupled to the cable modems 106 by coaxial cable 110. For clarity, only one coaxial cable is shown, however, all cable modems have a coaxial cable that connects them with the optical transceiver 104. To accommodate this, the transceiver 104 includes a plurality of interface ports 112, arranged to provide one port for each cable modem.

During applications that require the cable modems to transmit broadband upstream signals, each cable modem transmits its broadband upstream signal to the optical transceiver via its respective coaxial cable. The optical transceiver 104 receives the upstream broadband transmissions from the cable modems and converts these transmissions into an optical signal that contains all the broadband transmissions. Since the optical bandwidth available is very large, the broadband transmissions from all the cable modems can be accommodated in the one optical signal.

The optical transceiver then transmits the optical signal, via the fiber 108, upstream to the head-end, where it is processed by a head-end receiver. The head-end receiver may comprise any type of receiver suitable for receiving and processing the upstream optical signal to receive the upstream transmissions from each of the cable modems 106.

In another embodiment included in the present invention, an optical and coaxial modem 114 is coupled to the optical transceiver 104. The modem 114 outputs both optical and electrical signals. The optical signals can be transmitted directly on the fiber, while the electrical signals are input to the optical transceiver 104 via a coaxial cable 116. As a result, the electrical signals from the modem 114 can be included in the optical signal transmitted upstream from the optical transceiver 104. Therefore the system 100 provide for broadband electrical signals from multiple cable modems to be received by the optical transceiver 104, converted into an optical signal, and transmitted over a large bandwidth optical channel to the head-end for processing.

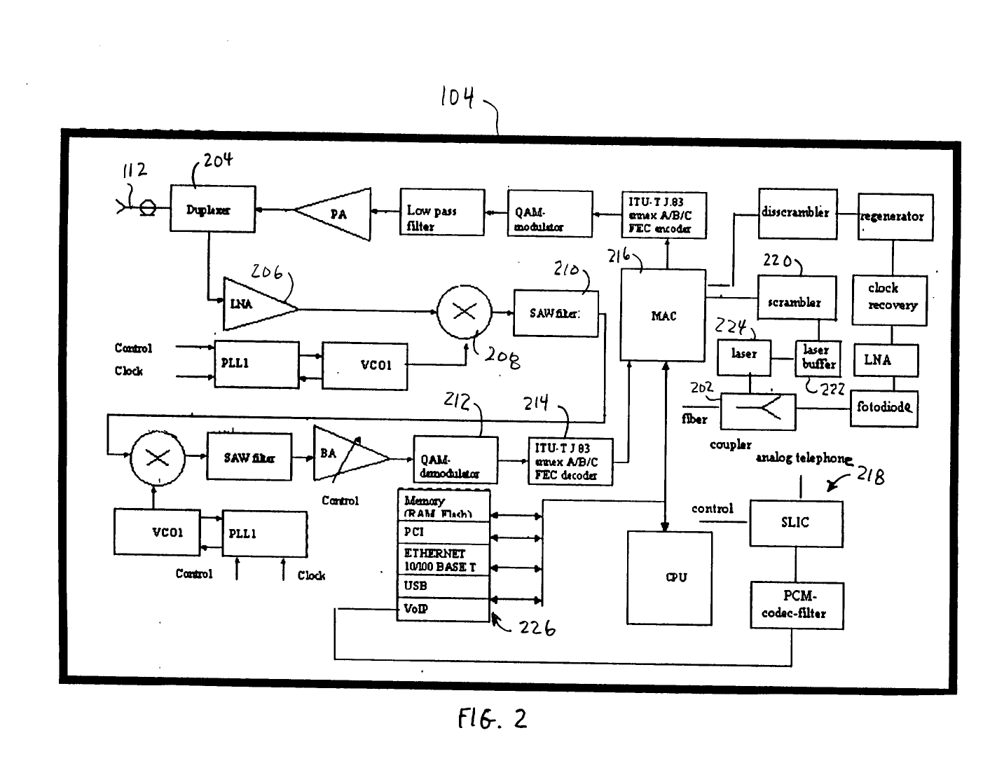

FIG. 2 is a block diagram of one embodiment of the optical transceiver 104 constructed in accordance with the present invention. The transceiver 104 includes a coupler 202 that couples to the optical fiber 108. The coupler 202 splits off the downstream optical signals for processing by the transceiver 104, and adds the upstream optical signal to the fiber.

A coaxial interface port 112 is shown coupled to a duplexer 204. The duplexer operates to receive the upstream electrical signal from a selected cable modem and transmit a downstream signal to the cable modem. The received broadband upstream signal flows to low noise amplifier 206, mixer 208, SAW filter 210 and on through several processing stages to reach a quadruture (QAM) demodulator 212 and decoder 214 (according to ITU-T J.83). The broadband signal ultimately reaches Media Access Controller (MAC) 216. The MAC is equipped with an Embedded Digital Certificate SIM/WIN that protects against unauthorized access.

Although shown as processing a signal coaxial broadband upstream signal, the transceiver 104 operates to process a plurality of broadband upstream signals received from a plurality of cable modems. The circuit that processes the other signals is identical to that shown, and so is not repeated in FIG. 2. These other signals are processed in an identical way and input to the MAC. The MAC also processes a telephone signal, as shown at 218, and other communication signals, such as an Ethernet or USB signal, as shown at 226. Thus, it is possible for voice signals or data to be communicated to the head-end.

The MAC receives all the upstream transmissions and combines them into a combined upstream broadband signal that is input to a scrambler 220. The output of the scrambler 220 is input to a laser buffer 222 and a laser 224. Lastly, the optical upstream broadband signal is input to the coupler 202 for transmission to the head-end via the optical fiber.

Therefore, in accordance with the present invention, an optical transceiver is provided that interfaces with a plurality of cable modems to receive a plurality of broadband electrical upstream signals and combine these upstream signals into an optical signal that is transmitted to the head-end. Any method of combining the electrical upstream signals into the optical signal can be used in accordance with the invention. The number of cable modems supported by one optical transceiver is selectable based on the network configuration and physical locations of the cable modems. In general, the optical transceiver should be positioned in close proximity to the cable modems so that the electrical signals transmitted over the coaxial cables do not degrade. These distances can be determined from known the characteristics of coaxial cable to transmit electrical signals having known frequency ranges.

The present invention includes an optical transceiver for use in a communication system that allows end users to transmit upstream broadband signals to a head end. The embodiments described above are illustrative of the present invention and are not intended to limit the scope of the invention to the particular embodiments described. Accordingly, while one or more embodiments of the invention have been illustrated and described, it will be appreciated that various changes can be made therein without departing from the spirit or essential characteristics thereof. Accordingly, the disclosures and descriptions herein are intended to be illustrative, but not limiting, of the scope of the invention, which is set forth in the following claims.

What is claimed is:

1. System for providing upstream broadband transmissions between a plurality of end users and a head-end in a cable communication system, the system comprising:
a first optical transceiver located at the head-end;
an optical transmission cable having a first end that is coupled to the first optical transceiver; and
a second optical transceiver located in close proximity to the end users, wherein the second optical transceiver is coupled to a second end of the optical transmission cable, and wherein the second optical transceiver comprises:
a plurality of interface ports, one port for each of the end users, to receive broadband upstream transmissions from each of the end users; and
logic to receive the broadband upstream transmissions and combine them into an optical signal that is transmitted on the optical transmission cable to the first optical transceiver.

2. An optical transceiver for providing upstream broadband transmissions between a plurality of end users and a head-end in a cable communication system, wherein the optical transceiver is located in close proximity to the plurality of end users, the transceiver comprising:
a plurality of interface ports, one port for each of the end users, to receive electrical broadband upstream transmissions from each of the end users;
an optical output port for transmitting optical signals to the head-end; and
logic to receive the electrical broadband upstream transmissions and combine them into an upstream optical signal that is transmitted from the optical output port to the head-end.

3. The optical transceiver of claim 2, wherein each of the interface ports comprises:
a duplexer to receive the electrical broadband upstream transmission;
a low noise amplifier coupled to a duplexer output;
a QAM demodulator coupled to a low noise amplifier output; and
a FEC decoder coupled to a QAM output.

4. The optical transceiver of claim 2, wherein the optical output port comprises:
a scrambler;
a laser buffer coupled to a scrambler output;
a laser coupled to a laser buffer output; and
an optical coupler coupled to a output of the laser.

5. The optical transceiver of claim 2, wherein each of the logic comprises:
a MAC coupled to the electrical broadband upstream transmissions; and
a telephone line interface coupled to receive an analog telephone signal.
